(19) United States
(12) Patent Application Publication
(10) Pub. No.: US 2006/0210274 A1
(43) Pub. Date: Sep. 21, 2006

(54) Apparatus For and Method of MAC Based Transmission in WDM Optical Ring Networks

(76) Inventors: Eyal Lichtman, Ramat Gan (IL); Erik Hendell, Tel Aviv (IL); Leonid Shmulevich, Rechovot (IL)

Correspondence Address: ZARETSKY & ASSOCIATES PC, 8753 W. RUNION DR., PEORIA, AZ, 85382-6412, US

(21) Appl. No.: 11/278,807

(22) Filed: Apr. 5, 2006

Related U.S. Application Data
(62) Division of application No. 09/777,581, filed on Feb. 6, 2001.

(51) Int. Cl. H04J 14/02

(52) U.S. Cl. 398/83

(57) ABSTRACT

An apparatus for and a method of direct MAC-to-MAC transmission over an optical ring network employing WDM or DWDM. In a first embodiment, the connections to the transmit and receive portions of two MAC devices in the node are crossed such that the transmitter and receiver of a MAC are not connected to the same optical add/drop multiplexer (OADM). The drop and add module of the OADM are connected in tandem on the same optical ring. A second OADM is similarly configured and located on the opposite optical ring. The receive and transmit portions of a MAC device are split across two OADMs wherein the receiver is connected to the drop module of one OADM and the transmitter is connected to the add module of the other OADM. In a second embodiment, the drop and add modules of each OADM are connected to opposite rings, i.e. the drop module is connected to an optical ring carrying traffic in one direction while the add module is connected to an optical ring carrying traffic flowing in the opposite direction. The drop and add functions for a particular optical ring are split across OADMs, rather than across MAC devices as is the case with the first embodiment described supra. Each MAC device is associated with the drop and add modules of the same OADM.

### REFERENCE TO PRIORITY APPLICATION

This application is a divisional of co-pending application U.S. Ser. No. 09/777,581, filed Feb. 6, 2001, entitled “Apparatus For and Method of MAC Based Transmission in WDM Optical Ring Networks,” hereby incorporated by reference in its entirety.

### FIELD OF THE INVENTION

The present invention relates generally to data communications and more particularly relates to an apparatus for and a method of Ethernet MAC based transmission in WDM optical ring networks.

### BACKGROUND OF THE INVENTION

Optical communication systems are becoming more and more widespread mainly due to the very large bandwidths they have for carrying information. The growth and diversity of lightwave networks, such as Wavelength Division Multiplexed (WDM) networks are placing new demands on all aspects of optical networks including, for example, capacity management and provisioning, maintenance, and reliable and robust operation. In addition, the current trend in many carrier networks is to implement standard IP based networks to achieve convergence of traditionally separate voice and data networks. To this end, the use of Ethernet based equipment in implanting carrier networks is becoming increasingly common.

Currently, high capacity optical networks are constructed as rings and use WDM technology to achieve high bandwidth capacities. For example, WDM ring networks are commonly used in metropolitan area network (MAN) applications but can also be used in LANs and WANs.

Wavelength division multiplexed (WDM) optical networks are particularly desirable because of their restoration capabilities and suitability for minimizing the optical fiber length for the interconnection of system nodes. A typical WDM optical ring network includes network elements with optical add/drop, multiplexer/demultiplexers (ADMs), etc., whereby some optical channels are dropped, some are added and/or other channels are expressed or passed through. In a ring topology each ring node is connected to exactly two other ring nodes. The ADMs are used to construct a ring network whereby adjacent ADMs are connected pair wise while the network nodes are situated so as to form a ring. In a ring network, any node can be reached from any other node using two physically separate paths, i.e. one traveling clockwise and one counter clockwise. This is used for providing protection against route failures. The use of at least two parallel fibers with traffic flowing in opposite directions provides restoration capabilities in the event of a fiber cut break.

An ADM functions to filter or drop one or more wavelengths transiting on the ring. The optical technologies usable for producing an ADM can be placed in two main categories, namely: (1) those using fixed filtering, whereby an ADM is produced for dropping and adding a fixed wavelength, and (2) those using tunable filtering, whereby an external control determines the wavelength of the dropped and added channel.

A block diagram illustrating MAC based transmission in a prior art optical ring network comprising a plurality of nodes is shown in FIG. 1. The network, generally referenced 10, comprises an optical ring network with a plurality of nodes 20, labeled node A, B and C. Each node is connected to a neighboring node via dual optical fibers 12, 14 wherein each fiber carries traffic in opposite directions. Optical fiber 12, for example, carries traffic in the clockwise direction, while optical fiber 14 carries traffic in the counter clockwise direction.

Each pair of optical fibers in a ring segment is terminated by a Media Access Control (MAC) device 22 comprising a receiver 26 and transmitter 24. The ring is constructed such that a transmitter in one node is connected to a receiver in another node. For example, the transmitter of the MAC in node A is connected to the receiver of the MAC in node B via optical fiber 14. Likewise, the transmitter of the MAC in node B is connected to the receiver of the MAC in node A via optical fiber 12.

Each node is adapted to contain at least two MAC devices. One MAC device enables Ethernet based communication with one neighboring node while the second MAC device enables Ethernet based communication with the other neighboring node. For example, one MAC device in node A enables Ethernet based communication with node B and the other MAC device enables Ethernet based communication with node C.

Both MAC devices are connected to ports in an Ethernet device 18 such as a hub, switch, etc. The Ethernet device may be part of a network and connected to one or more additional Ethernet enabled devices 16.

In this fashion, the MAC device in each node is connected via fiber to a MAC device in another node. Thus, communications always occurs from one MAC device to another MAC device. A disadvantage of such a configuration, however, is that it is not a true ring architecture in that the ring actually comprises a plurality of independent segments connecting one MAC device to another. The architecture actually comprises a plurality of point-to-point segments constructed in circular fashion. Such a configuration cannot support a Wave Division Multiplexing (WDM) based optical ring architecture due to the MAC-to-MAC communications restriction of the network 10.

Conventional optical ring networks support communication using WDM and DWDM. A block diagram illustrating MAC based transmission in a conventional prior art optical ring network comprising a plurality of Optical Add/Drop Multiplexers (OADMs) is shown in FIG. 2. In this optical network, a plurality of nodes 30 is connected by pairs of optical fiber. Each node comprises at least two OADMs 32, 38, one for each direction of the ring.

In the counter clockwise direction, traffic enters node A via optical fiber 44 to OADM 32. A channel 74 having a particular wavelength is dropped via drop module 34 while another channel 72 carrying different data is added to the traffic via add module 36. The traffic is carried to the neighboring node B via optical fiber 46. The channel dropped 74 output by the drop module 34 is input to a receiver 64 in MAC device 60. The channel added 72 is output by the transmitter 62 in MAC device 60 and input to add module 36.

In the clockwise direction, traffic from node B enters node A via optical fiber 48 to OADM 38. A channel 41 having a particular wavelength is dropped via drop module 40 while another channel 43 carrying different data is added to the traffic via add module 42. The traffic is carried to the neighboring node via optical fiber 50. The channel dropped 41 output by the drop module 40 is input to a receiver 47 in a second MAC device 49. The channel 43 added is output by the transmitter 45 in MAC device 49 and input to add module 42.

Each MAC device 60, 49 is connected to an Ethernet device 66 which may comprise a hub or switch, for example. One or more additional Ethernet devices 68 may be connected to the Ethernet switch 66. The Ethernet device functions to connect the MAC devices 60, 49 to an Ethernet network (not shown), running any desired protocol, e.g., the TCP/IP protocol of the Internet.

Neighboring node B is configured similarly to that of node A and comprises at least a pair of OADMs and MACs, where an individual MAC device is associated with each OADM.

The use of OADMs in the nodes along the ring, support the use of multiple wavelengths of light using conventional WDM techniques. The configuration of OADMs and MAC devices also permits MAC based communications over the ring.

A disadvantage of this architecture, however, is that any two MAC devices in different nodes cannot communicate bi-directionally between each other, i.e. communications between two MACs is not symmetrical. Consider communications between nodes A and B. The transmitter 62 in MAC device 60 in node A communicates with the receiver in MAC device 61 in node B directly over optical fiber 46. In the reverse direction, however, the transmitter of MAC device 61 in node B does not communicate directly with the receiver 64 in MAC device 60 in node A. Rather, the data channel output of the transmitter in MAC 61 is added to the traffic flowing in the counter clockwise ring. Thus, the data must traverse the entire ring in the counter clockwise direction, enter OADM 32 and be dropped before arriving at the receiver 64 in MAC device 60.

This type of ring architecture thus cannot support direct MAC-to-MAC communications. Using this prior art configuration, data in one of either two directions (i.e. receive or transmit) will arrive at the correct MAC device. This limitation prevents wavelength re-use around the ring, since the wavelength for a particular connection must be preserved to permit communications from MAC to MAC.

Thus, there is a need for an optical ring mechanism employing ADMs in the network nodes that enables direct MAC-to-MAC transmission of information through the network. This would facilitate the transport of IP/Ethernet based communications over optical ring networks.

### SUMMARY OF THE INVENTION

The present invention provides an apparatus for and a method of direct MAC-to-MAC transmission over an optical ring network employing WDM or DWDM. Use of the present invention facilitates the transport of IP/Ethernet frame data over WDM and DWDM based optical ring networks. Applications of the invention include, but are not limited to, the transport of TDM streams such as E1, T1, etc. via Ethernet frames using suitably adapted equipment. The Ethernet frames are then transmitted, using the invention, directly from MAC to MAC over the optical ring network. The MAC based transmission of Ethernet frames over existing transport facilities such as optical fiber rings, etc. enables Network Service Providers (NSPs) to offer more services for reduced cost.

In a first embodiment, the invention overcomes the problems associated with the prior art by crossing the connections to the transmit and receive portions of the two MAC devices such that the transmitter and receiver of a MAC are not connected to the same OADM. The drop and add module of the OADM are connected in tandem on the same optical ring. A second OADM is similarly configured and located on the opposite optical ring.

The receive and transmit portions of a MAC device are split across two OADMs wherein the receiver is connected to the drop module of one OADM and the transmitter is connected to the add module of the other OADM.

Thus, the invention enables the direct MAC-to-MAC transmission over optical rings that employ wave division multiplexing. Each MAC device in a node is connected so as to permit direct communications with another MAC device located in a neighboring node on the optical ring.

In a second embodiment, the drop and add modules of each OADM are connected to opposite rings, i.e. the drop module is connected to an optical ring carrying traffic in one direction while the add module is connected to an optical ring carrying traffic flowing in the opposite direction. Thus, the drop and add functions for a particular optical ring are split across OADMs, rather than across MAC devices as is the case with the first embodiment described supra. Each MAC device is associated with the drop and add modules of the same OADM.

This embodiment also enables direct MAC-to-MAC transmission over optical rings employing wave division multiplexing. Each MAC device in a node is connected so as to permit direct communications with another MAC device located in a neighboring node on the optical ring.

This provides improved reliability since a failure of an OADM only effects one MAC device, rather than two, as is the case in the first embodiment. Communications is disrupted to only one of the neighboring nodes. Using the second OADM and associated MAC device, the node is still able to communicate to the second neighboring node.

There is thus provided in accordance with the present invention an apparatus for providing Media Access Control (MAC) based transmission in a Wave Division Multiplexing (WDM) optical network comprising a first OADM configured to communicate on a first fiber ring, the first OADM comprising a first add module and a first drop module, wherein the first drop module is adapted to drop a first channel from a first ingress multi-wavelength input transmitted over the first fiber ring and wherein the first add module is adapted to add a second channel onto a first egress multi-wavelength output transmitted over the first fiber ring, a second OADM configured to communicate on a second fiber ring, the second OADM comprising a second add module and a second drop module, wherein the second drop module is adapted to drop a third channel from a second ingress multi-wavelength input transmitted over the second fiber ring and wherein the second add module is adapted to add a fourth channel onto a second egress multi-wavelength output transmitted over the second fiber ring, a first MAC module comprising a first transmitter and a first receiver, wherein the first transmitter is adapted to provide the fourth channel added by the second add module and wherein the first receiver is adapted to receive the first channel dropped by the first drop module such that the first MAC transmits and receives data on the same segment of the first fiber ring and the second fiber ring and a second MAC module comprising a second transmitter and a second receiver, wherein the second transmitter is adapted to provide the second channel added by the first add module and wherein the second receiver is adapted to receive the third channel dropped by the second drop module such that the second MAC transmits and receives data on the same segment of the first fiber ring and the second fiber ring.

There is also provided in accordance with the present invention a method of providing Media Access Control (MAC) based transmission in a Wave Division Multiplexing (WDM) optical network, the method comprising the steps of providing a first OADM configured to communicate on a first fiber ring, the first OADM comprising a first add module and a first drop module, providing a second OADM configured to communicate on a second fiber ring, the second OADM comprising a second add module and a second drop module, providing a first MAC module comprising a first transmitter and a first receiver, providing a second MAC module comprising a second transmitter and a second receiver, dropping a first channel received from a first ingress multi-wavelength input received by the first drop module in the first OADM to the first receiver in the first MAC module, adding a fourth channel from the first transmitter in the first MAC to a second egress multi-wavelength output transmitted by the second add module in the second OADM, dropping a third channel received from a second ingress multi-wavelength input received by the second drop module in the second OADM to the second receiver in the second MAC module, adding a second channel from the second transmitter in the second MAC to a first egress multi-wavelength output transmitted by the first add module in the first OADM, wherein the second MAC transmits and receives data on the same segment of the first fiber ring and the second fiber ring and wherein the first MAC transmits and receives data on the same segment of the first fiber ring and the second fiber ring.

There is further provided in accordance with the present invention an apparatus for providing Media Access Control (MAC) based transmission in a Wave Division Multiplexing (WDM) optical network comprising a first OADM comprising a first add module and a first drop module, wherein the first drop module is adapted to drop a first channel from a first ingress multi-wavelength input transmitted over a first fiber ring and wherein the first add module is adapted to add a second channel onto a second egress multi-wavelength output transmitted over a second fiber ring, a second OADM comprising a second add module and a second drop module, wherein the second drop module is adapted to drop a third channel from a second ingress multi-wavelength input transmitted over the second fiber ring and wherein the second add module is adapted to add a fourth channel onto the first egress multi-wavelength output transmitted over the first fiber ring, a first MAC module comprising a first transmitter and a first receiver, wherein the first transmitter is adapted to provide the second channel added by the second add module and wherein the first receiver is adapted to receive the first channel dropped by the first drop module such that the first MAC transmits and receives data on the same segment of the first fiber ring and the second fiber ring and a second MAC module comprising a second transmitter and a second receiver, wherein the second transmitter is adapted to provide the fourth channel added by the second add module and wherein the second receiver is adapted to receive the third channel dropped by the second drop module such that the second MAC transmits and receives data on the same segment of the first fiber ring and the second fiber ring.

There is also provided in accordance with the present invention a method of providing Media Access Control (MAC) based transmission in a Wave Division Multiplexing (WDM) optical network, the method comprising the steps of providing a first OADM comprising a first add module and a first drop module, providing a second OADM comprising a second add module and a second drop module, providing a first MAC module comprising a first transmitter and a first receiver, providing a second MAC module comprising a second transmitter and a second receiver, connecting the first add module to a second fiber ring and the first drop module to a first fiber ring, connecting the second add module to the first fiber ring and the second drop module to the second fiber ring, dropping a first channel in a first ingress multi-wavelength input received over the first fiber ring by the first drop module in the first OADM to the first receiver in the first MAC module, adding a second channel from the first transmitter in the first MAC to a second egress multi-wavelength output transmitted over the second fiber ring via the first add module in the first OADM, dropping a third channel in a second ingress multi-wavelength input received over the second fiber ring by the second drop module in the second OADM to the second receiver in the second MAC module, adding a fourth channel from the second transmitter in the second MAC to a first egress multi-wavelength output transmitted over the first fiber ring via the second add module in the second OADM, wherein the second MAC transmits and receives data on the same segment of the first fiber ring and the second fiber ring and wherein the first MAC transmits and receives data on the same segment of the first fiber ring and the second fiber ring.

There is still further provided in accordance with the present invention a method of providing Media Access Control (MAC) based transmission in an optical network employing Wave Division Multiplexing (WDM), the method comprising the steps of providing a OADM comprising an add module and a drop module, providing a MAC device comprising a transmitter and a receiver, connecting the add module to a first fiber ring and the drop module to a second fiber ring, dropping a first channel in an ingress multi-wavelength input received over the second fiber ring by the drop module to the receiver in the MAC module, adding a second channel from the transmitter in the MAC to an egress multi-wavelength output transmitted over the first fiber ring via the add module and wherein the MAC transmits and receives data on the same segment of the first fiber ring and the second fiber ring.

There is also provided in accordance with the present invention a method of providing Media Access Control (MAC) based transmission in an optical network employing Wave Division Multiplexing (WDM), the method comprising the steps of providing a first OADM located in a first node, the first OADM comprising a first add module and a first drop module, providing a second OADM located in a second node, the second OADM comprising a second add module and a second drop module, providing a first MAC device comprising a first transmitter and a first receiver, the first MAC device located in the first node, providing a second MAC device comprising a second transmitter and a second receiver, the second MAC device located in the second node, connecting the first add module to a first fiber ring and the first drop module to a second fiber ring, connecting the second add module to the second fiber ring and the second drop module to the first fiber ring, dropping a first channel in a second ingress multi-wavelength input received over the second fiber ring by the first drop module in the first node to the first receiver in the first node, adding a second channel from the first transmitter in the first MAC device to a first egress multi-wavelength output transmitted over the first fiber ring via the first add module in the first node, dropping a third channel in a first ingress multi-wavelength input received over the first fiber ring by the second drop module in the second node to the second receiver in the second node, adding a fourth channel from the second transmitter in the second node to a second egress multi-wavelength output transmitted over the second fiber ring via the second add module in the second node and wherein the first MAC device in the first node transmits and receives data to and from the second MAC device in the second node on the same segment of the first fiber ring and the second fiber ring.

### BRIEF DESCRIPTION OF THE DRAWINGS

The invention is herein described, by way of example only, with reference to the accompanying drawings, wherein:

FIG. 1 is a block diagram illustrating MAC based transmission in a prior art optical ring network comprising a plurality of nodes;

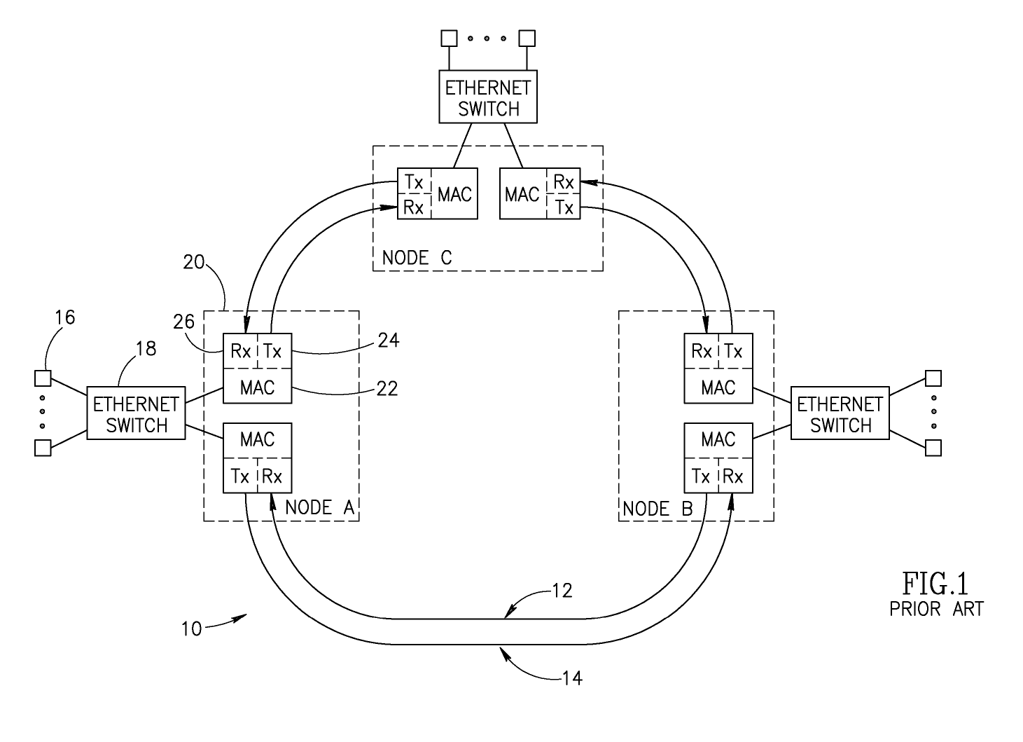

FIG. 2 is a block diagram illustrating MAC based transmission in a prior art optical ring network comprising a plurality of Optical Add/Drop Multiplexers (OADMs);

FIG. 3 is a block diagram illustrating MAC based transmission in an optical ring network constructed in accordance with a first embodiment of the present invention; and

FIG. 4 is a block diagram illustrating MAC based transmission in an optical ring network constructed in accordance with a second embodiment of the present invention.

### DETAILED DESCRIPTION OF THE INVENTION

### Notation Used Throughout

The following notation is used throughout this document.

| Term | Definition |
|---|---|
| ADM | Add Drop Multiplexer |
| DWDM | Dense Wave Division Multiplexing |
| IP | Internet Protocol |
| ISO | International Standards Organization |
| LAN | Local Area Network |
| MAC | Media Access Control |
| MAN | Metropolitan Area Network |
| NSP | Network Service Provider |
| OADM | Optical Add Drop Multiplexer |
| OSI | Open Systems Interconnection |
| PDU | Protocol Data Unit |
| TCP | Transmission Control Protocol |
| WAN | Wide Area Network |
| WDM | Wave Division Multiplexing |

### DETAILED DESCRIPTION OF THE INVENTION

The present invention provides an apparatus for and a method of MAC based transmission in WDM optical ring networks. Use of the present invention facilitates the transport of IP/Ethernet frame data over WDM and DWDM based optical ring networks. Applications of the invention include, but are not limited to, the transport of TDM streams such as E1, T1, etc. via Ethernet frames using suitably adapted equipment. The Ethernet frames are then transmitted, using the invention, directly from MAC to MAC over the optical ring network. The MAC based transmission of Ethernet frames over existing transport facilities such as optical fiber rings, etc. enables Network Service Providers (NSPs) to offer more services for reduced cost.

For illustration purposes, the principles of the present invention are described in the context of an example node embodiment employing at least two ADMs corresponding to a single wavelength. Throughout this document, the term add drop multiplexer means transmission equipment which adds and drop information from an optical ring to/from one or more switching elements. It is noted that although the invention is described in the context of OADMs, the invention is not limited thereto. The invention is applicable to any type of wavelength based multiplexing/demultiplexing device. Thus, the term OADM is intended to refer to any wavelength based multiplexing/demultiplexing device.

Although, an example is presented illustrating the drop and add of a single wavelength, it is appreciated that the invention can be applied to nodes comprising any number of ADMs which are adapted to support dropping and adding any desired number of wavelengths. In addition, it is not intended that the invention be limited to the configurations and embodiments described herein. It is appreciated that one skilled in the art may apply the principles of the present invention to numerous other types of network configurations employing direct MAC based transmission, whether optical or electrical, without departing from the spirit and scope of the invention.

Note that throughout this document, references are made to Ethernet frames and IP packets which are example protocol data units (PDUs) associated with various networks such as Ethernet, H.323, ISO OSI TCP/IP protocol stack. It is appreciated, however, that the invention may be adapted for use in other types of networks that transmit other types of PDUs as well. The principles of MAC based transmission as described herein are not limited to Ethernet MAC devices and can be applied to other types of Layer 2 protocols and devices as well.

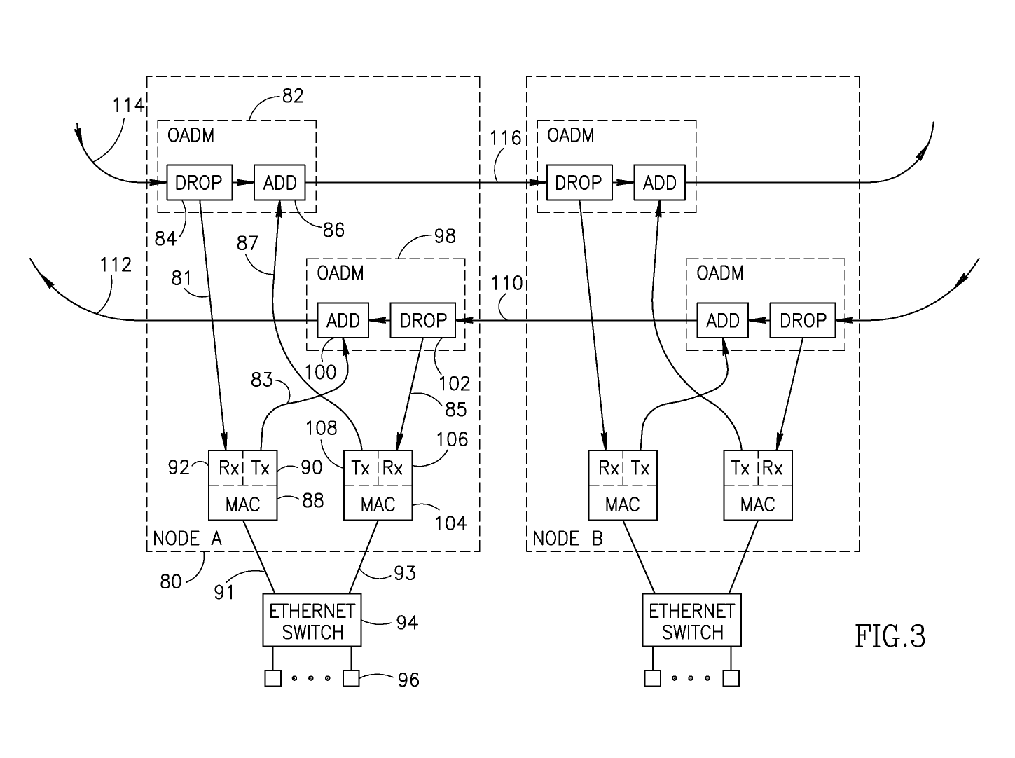

A first embodiment of the MAC based transmission scheme of the present invention will now be described. A block diagram illustrating MAC based transmission in an optical ring network constructed in accordance with a first embodiment of the present invention is shown in FIG. 3. A portion of an optical ring network is presented that illustrates two nodes, generally referenced 80, and labeled node A and node B. Any number of nodes may be situated on the optical ring. In this optical network, a plurality of nodes 80 are connected by pairs of optical fiber. Each node 80 comprises at least two OADMs 82, 98, one for each direction of the ring and a separate MAC device for each OADM.

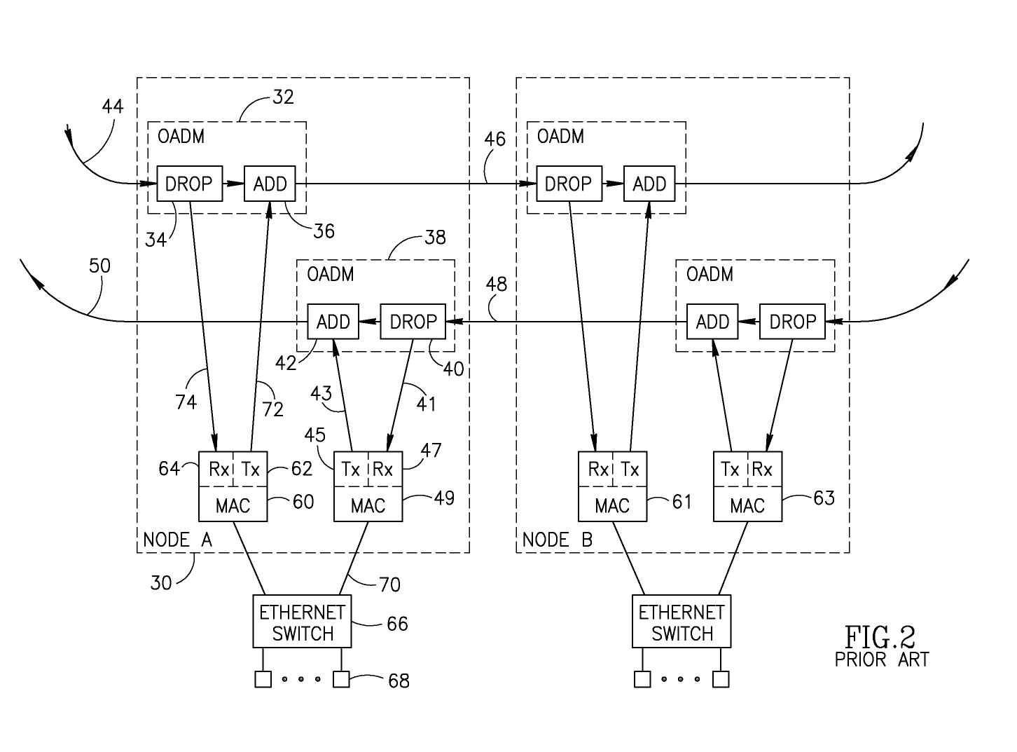

In accordance with the invention, the connections to the transmit and receive portions of the two MAC devices are crossed such that the transmitter and receiver of a MAC are not connected to the same OADM. For example, the transmitter 90 of MAC device 88 is connected to the add module 100 of OADM 98 located on the clockwise ring, while the receiver 92 of MAC device 88 is connected to the drop module 84 in OADM 82 located on the counter clockwise ring. Similarly, the transmitter 108 of MAC device 104 is connected to the add module 86 of OADM 82 located on the clockwise ring, while the receiver 106 of MAC device 104 is connected to the drop module 102 in OADM 98 located on the counter clockwise ring. This is contrast to the prior art technique (see FIG. 2) of connecting the transmitter and receiver of a MAC directly to the drop and add modules of the same OADM.

In operation, traffic to and from a neighboring node to the left of node A is handled as follows. Traffic from the neighboring node enters node A via optical fiber 114 to OADM 82. A channel 81 having a particular wavelength is dropped via drop module 84 in OADM 82 and input to the receiver 92 in MAC device 88. Traffic returning to the neighboring node via optical fiber 112 is provided by the transmitter 90 in MAC device 88. The channel 83 is added to the multiple wavelength optical output by the add module 100 in OADM 98.

The MAC device 88 is connected to an Ethernet device 94 via connection 91. The Ethernet device 94 may comprise any suitable Ethernet device such as a hub, switch, etc. One or more additional Ethernet devices 96 may be connected to the Ethernet switch 94. The Ethernet device functions to connect the MAC device 88 to an Ethernet TCP/IP based network (not shown), such as the Internet.

Traffic from neighboring node B enters node A via optical fiber 110 to OADM 98. A channel 85 having a particular wavelength is dropped via drop module 102 in OADM 98. The channel 85 dropped in input to the receiver 106 of MAC device 104. Traffic returning to node B via optical fiber 116 is provided by the transmitter 108 in MAC device 104. The channel 87 is added to the multiple wavelength optical output by the add module 86 in OADM 82. The MAC device 104 is connected to the Ethernet device 94 via connection 93. The Ethernet device functions to connect the MAC device 104 to an Ethernet TCP/IP based network (not shown), such as the Internet.

Neighboring node B is configured similarly to that of node A and comprises at least a pair of OADMs and MACs, where the transmitter and receiver of each individual MAC device are connected to two different OADMs, each located on opposite rings.

Thus, the first embodiment of the present invention enables direct MAC-to-MAC transmission over optical rings that employ wave division multiplexing. Each MAC device in a node is connected so as to permit direct communications with another MAC device located in a neighboring node connected to the same segment of the optical ring.

Note that each OADM is adapted to drop and add a particular wavelength. Additional wavelengths can be handled using additional OADMs, each adapted to drop and add a different wavelength. Each pair of OADMs have associated with them a complimentary pair of MAC devices configured in accordance with the present invention.

A disadvantage of this configuration, however, is that the drop and add functions associated with an individual MAC are split over two separate OADMs. A failure of a single OADM will disrupt communications over two MAC devices. In this case, the node is prevented from communicating to both its neighbors. The reliability of communications can be improved by modifying the configuration of the OADM such that the drop and add modules are associated with opposite rings, rather than the same ring. The second embodiment of the present invention, presented herein, provides an improved configuration of OADM while providing direct MAC-to-MAC transmission over the optical ring.

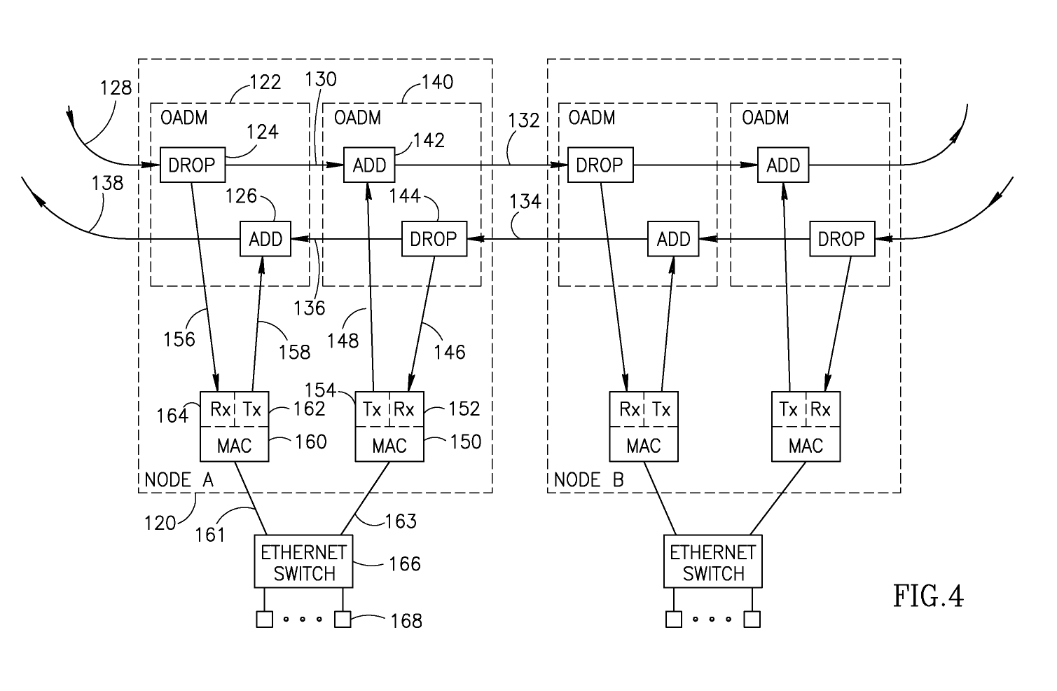

A second embodiment of the MAC based transmission scheme of the present invention will now be described. A block diagram illustrating MAC based transmission in an optical ring network constructed in accordance with a second embodiment of the present invention is shown in FIG. 4.

A portion of an optical ring network is presented that illustrates two nodes, generally referenced 120, and labeled node A and node B. Any number of nodes may be situated on the optical ring. In the optical network shown, a plurality of nodes 120 are connected by pairs of optical fiber. Each node 120 comprises at least two OADMs 122, 140, each OADM associated with both ring directions. Each OADM has associated with it a separate MAC device.

In accordance with the invention, the drop and add modules of each OADM are connected to opposite rings, i.e. the drop module is connected to an optical ring carrying traffic in one direction while the add module is connected to an optical ring carrying traffic flowing in the opposite direction. Thus, the drop and add functions for a particular optical ring are split across OADMs, rather than across MAC devices as is the case with the first embodiment described supra. Each MAC device is associated with the drop and add modules of the same OADM.

For example, the transmitter 162 of MAC device 160 is connected to the add module 126 of OADM 122 located on the clockwise ring, while the receiver 164 of MAC device 160 is connected to the drop module 124 in OADM 122 located on the opposite ring. Similarly, the transmitter 154 of MAC device 150 is connected to the add module 142 of OADM 140 located on the clockwise ring, while the receiver 152 of MAC device 150 is connected to the drop module 144 in OADM 140 located on the opposite ring, i.e. the clockwise ring.

In operation, traffic to and from a neighboring node to the left of node A is handled by a single OADM and corresponding MAC device as follows. Traffic from the neighboring node enters node A via optical fiber 128 to OADM 122. A channel 156 having a particular wavelength is dropped via drop module 124 in OADM 122 and input to the receiver 164 in MAC device 160. Traffic returning to the neighboring node via optical fiber 138 is provided by the transmitter 162 in MAC device 160. The channel 158 is added to the multiple wavelength optical output by the add module 126 in OADM 122.

The MAC device 160 is connected to an Ethernet device 166 via connection 161. The Ethernet device 166 may comprise any suitable Ethernet device such as a hub, switch, etc. One or more additional Ethernet devices 168 may be connected to the Ethernet switch 166. The Ethernet device functions to connect the MAC device 160 to an Ethernet TCP/IP based network (not shown), such as the Internet.

On the other side of node A, traffic from neighboring node B enters node A via optical fiber 134 to OADM 140. A channel 146 having a particular wavelength is dropped via drop module 144 in OADM 140. The channel 146 dropped in input to the receiver 146 of MAC device 150. Traffic returning to node B via optical fiber 132 is provided by the transmitter 154 in MAC device 150. The channel 148 is added to the multiple wavelength optical output by the add module 142 in OADM 140. The MAC device 150 is connected to the Ethernet device 166 via connection 163. The Ethernet device functions to connect the MAC device 150 to an Ethernet TCP/IP based network (not shown), such as the Internet.

Note that neighboring node B is configured similarly to that of node A and comprises at least a pair of OADMs and MACs, wherein the transmitter and receiver of each individual MAC device are connected to the same OADM. The drop and add modules of each OADM are connected to opposite rings.

Thus, the second embodiment of the present invention enables direct MAC-to-MAC transmission over optical rings that employ wave division multiplexing. Each MAC device in a node is connected so as to permit direct communications with another MAC device located in a neighboring node connected to the same segment of the optical ring on the optical ring.

An advantage of the second embodiment is that the drop and add functions associated with an individual MAC are associated with a single OADM. Thus, a failure of an OADM effects only a single MAC device. In this case, the node is still able to communicate to one of its neighbors over the optical ring using the second OADM and associated MAC device. The reliability of communications is thus improved by splitting the drop and add functions of an OADM across opposite directions of the optical ring. The second embodiment of the present invention therefore provides an improved configuration of OADM while providing direct MAC-to-MAC transmission over the optical ring.

Note that additional wavelengths can be accommodated on the optical ring by adding additional OADMs and corresponding MAC devices. Each OADM added to a node is configured to operate using a unique wavelength.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. An apparatus for providing Media Access Control (MAC) based transmission in a Wave Division Multiplexing (WDM) optical network, comprising:
a first optical add/drop multiplexer (OADM) configured to communicate on a first fiber ring, said first OADM comprising a first add module and a first drop module, wherein said first drop module is adapted to drop a first channel from a first ingress multi-wavelength input transmitted over said first fiber ring and wherein said first add module is adapted to add a second channel onto a first egress multi-wavelength output transmitted over said first fiber ring;
a second OADM configured to communicate on a second fiber ring, said second OADM comprising a second add module and a second drop module, wherein said second drop module is adapted to drop a third channel from a second ingress multi-wavelength input transmitted over said second fiber ring and wherein said second add module is adapted to add a fourth channel onto a second egress multi-wavelength output transmitted over said second fiber ring;
a first MAC module comprising a first transmitter and a first receiver, wherein said first transmitter is adapted to provide said fourth channel added by said second add module and wherein said first receiver is adapted to receive said first channel dropped by said first drop module such that said first MAC transmits and receives data on the same segment of said first fiber ring and said second fiber ring; and
a second MAC module comprising a second transmitter and a second receiver, wherein said second transmitter is adapted to provide said second channel added by said first add module and wherein said second receiver is adapted to receive said third channel dropped by said second drop module such that said second MAC transmits and receives data on the same segment of said first fiber ring and said second fiber ring.

2. The apparatus according to claim 1, wherein said first channel, said second channel, said third channel and said fourth channel comprise the same optical wavelength.

3. The apparatus according to claim 1, wherein the optical wavelength used by said first channel and said second channel is different than that used by said third channel and said fourth channel.

4. The apparatus according to claim 1, wherein the optical wavelength used by said first channel, said second channel, said third channel and said fourth channel are all different.

5. The apparatus according to claim 1, wherein said first MAC module is connected to an Ethernet device.

6. The apparatus according to claim 5, wherein said Ethernet device comprises an Ethernet switch.

7. The apparatus according to claim 1, wherein said second MAC module is connected to an Ethernet device.

8. The apparatus according to claim 7, wherein said Ethernet device comprises an Ethernet switch.

9. The apparatus according to claim 1, further comprising one or more additional sets, each set comprising a first OADM, second OADM, first MAC module and second MAC module, whereby each set added is assigned a unique operating wavelength.

10. A method of providing Media Access Control (MAC) based transmission in a Wave Division Multiplexing (WDM) optical network, said method comprising the steps of:
providing a first optical add/drop multiplexer (OADM) configured to communicate on a first fiber ring, said first OADM comprising a first add module and a first drop module;
providing a second OADM configured to communicate on a second fiber ring, said second OADM comprising a second add module and a second drop module;
providing a first MAC module comprising a first transmitter and a first receiver;
providing a second MAC module comprising a second transmitter and a second receiver;
dropping a first channel received from a first ingress multi-wavelength input received by said first drop module in said first OADM to said first receiver in said first MAC module;
adding a fourth channel from said first transmitter in said first MAC to a second egress multi-wavelength output transmitted by said second add module in said second OADM;
dropping a third channel received from a second ingress multi-wavelength input received by said second drop module in said second OADM to said second receiver in said second MAC module;
adding a second channel from said second transmitter in said second MAC to a first egress multi-wavelength output transmitted by said first add module in said first OADM;
wherein said second MAC transmits and receives data on the same segment of said first fiber ring and said second fiber ring; and
wherein said first MAC transmits and receives data on the same segment of said first fiber ring and said second fiber ring.

11. The method according to claim 10, wherein said first channel, said second channel, said third channel and said fourth channel comprise the same optical wavelength.

12. The method according to claim 10, wherein the optical wavelength used by said first channel and said second channel is different than that used by said third channel and said fourth channel.

13. The method according to claim 10, wherein the optical wavelength used by said first channel, said second channel, said third channel and said fourth channel are all different.

14. The method according to claim 10, wherein said first MAC module is connected to an Ethernet device.

15. The method according to claim 14, wherein said Ethernet device comprises an Ethernet switch.

16. The method according to claim 10, wherein said second MAC module is connected to an Ethernet device.

17. The method according to claim 16, wherein said Ethernet device comprises an Ethernet switch.

18. The method according to claim 10, further comprising the step of adding one or more additional sets, each set comprising a first OADM, second OADM, first MAC module and second MAC module, whereby each set added is assigned a unique operating wavelength.
